(19) United States
(12) Patent Application Publication
(10) Pub. No.: US 2013/0053058 A1
(43) Pub. Date: Feb. 28, 2013

(54) METHODS AND APPARATUSES FOR TRANSITIONING BETWEEN INTERNET AND BROADCAST RADIO SIGNALS

(71) Applicant: Xintian Li, San Diego, CA (US)

(72) Inventor: Xintian Li, San Diego, CA (US)

(73) Assignee: QUALCOMM Incorporated, San Diego, CA (US)

(21) Appl. No.: 13/223,229

(22) Filed: Aug. 31, 2011

(51) Int. Cl. H04W 24/00; H04B 7/00

(52) U.S. Cl. 455/456.1; 455/230

(57) ABSTRACT

Techniques are provided which may be implemented using various methods and/or apparatuses in a mobile device to allow the mobile device to smoothly transition audio input between a current radio signal and a target radio signal received at a mobile device. In one embodiment, the mobile device determines the current radio signal; selects the target radio signal; determines an earlier radio signal comprising the current radio signal or the target radio signal; creates a buffered radio signal by storing the earlier radio signal; transitions from the current radio signal to the buffered radio signal; determines the time offset between the buffered radio signal and the target radio signal; compares the determined time offset to an acceptable time offset; and transitions from the buffered radio signal to the target radio signal.

### BACKGROUND

1. Field

The subject matter disclosed herein relates to electronic devices, and more particularly to methods and apparatuses for use in or with a mobile device having broadcast radio and Internet radio capabilities.

2. Information

AM and FM radio broadcasts are optimized for low cost local access by devices containing AM and/or FM receivers. Broadcast radio is generally freely available and is highly efficient where a single broadcast tower may be serving virtually unlimited numbers of receivers within broadcast range. However, broadcast radio may be less optimal for moving receivers where a given receiver, such as in an automobile, may eventually move out of range and lose the broadcast signal.

Many radio stations are also available over the Internet and can be accessed from wireless Internet-based devices. Wireless Internet connections have the advantage of being contiguously available where wireless devices may transition between data-capable cell sites. However, wireless Internet devices consume data bandwidth and are therefore more expensive to provide.

Wireless carriers may reduce ongoing data expenses by equipping wireless devices with AM/FM receivers, thereby allowing mobile users to receive broadcast radio, where available, rather than utilizing a data connection over the network. However, because any given radio broadcast signal is localized to a particular geographic area, maintaining a continuous connection to a radio station may require transitioning to an Internet-based broadcast of the same signal. Typically, the Internet and broadcast signals will not be synchronized and the transition between the two will result in a discontinuity in the audio performance, possibly exemplified by either repeated audio or deleted audio.

### SUMMARY

Some example techniques are presented herein which may be implemented in various methods and apparatuses in a mobile device to provide for or otherwise support a more seamless transition between broadcast and Internet-based radio signals in a mobile device.

In accordance with one example implementation, a method may be provided for transitioning audio input between a current radio signal and a target radio signal received at a mobile device, comprising: selecting the target radio signal; comparing the target radio signal to the current radio signal; determining an earlier radio signal comprising the current radio signal or the target radio signal; creating a buffered radio signal by storing the earlier radio signal; transitioning from the current radio signal to the buffered radio signal; determining a time offset between the buffered radio signal and the target radio signal; comparing the determined time offset to an acceptable time offset; and transitioning from the buffered radio signal to the target radio signal.

In accordance with another example implementation, a mobile device may be provided for transitioning audio input between a current radio signal and a target radio signal comprising: means for selecting the target radio signal; means for comparing the target radio signal to the current radio signal; means for determining an earlier radio signal comprising the current radio signal or the target radio signal; means for creating a buffered radio signal by storing the earlier radio signal; means for transitioning from the current radio signal to the buffered radio signal; means for determining a time offset between the buffered radio signal and the target radio signal; means for comparing the determined time offset to an acceptable time offset; and means for transitioning from the buffered radio signal to the target radio signal.

In accordance with yet another example implementation, a mobile device may be provided for transitioning audio input between a current radio signal and a target radio signal comprising: a radio receiver; a wireless transceiver; and one or more processing units to: select the target radio signal; compare the target radio signal to the current radio signal; determine an earlier radio signal comprising the current radio signal or the target radio signal; create a buffered radio signal by storing the earlier radio signal; transition from the current radio signal to the buffered radio signal; determine a time offset between the buffered radio signal and the target radio signal; compare the determined time offset to an acceptable time offset; and transition from the buffered radio signal to the target radio signal.

In accordance with still another example implementation, an article may be provided comprising: a computer readable medium having stored therein computer executable instructions, for transitioning audio input between a current radio signal and a target radio signal received at a mobile device, executable by one or more processing units of a mobile device to: select the target radio signal; compare the target radio signal to the current radio signal; determine an earlier radio signal comprising the current radio signal or the target radio signal; create a buffered radio signal by storing the earlier radio signal; transition from the current radio signal to the buffered radio signal; determine a time offset between the buffered radio signal and the target radio signal; compare the determined time offset to an acceptable time offset; and transition from the buffered radio signal to the target radio signal.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an exemplary mobile device capable of receiving Internet radio, broadcast radio and satellite positioning system (SPS) signals, in accordance with an implementation.

FIG. 2 is a system diagram illustrating certain features of a system containing a mobile device capable of transitioning between an Internet radio signal communicated over wireless signals and a broadcast radio signal, in accordance with an implementation.

FIG. 3 is a flow diagram illustrating certain features of an exemplary process for use in a mobile device to transition from an current radio signal to a target radio signal, in accordance with an implementation.

FIG. 4A is a flow diagram illustrating certain features of an exemplary process for use in a mobile device to transition from an earlier radio signal to a later radio signal, in accordance with an implementation.

FIG. 4B is a flow diagram illustrating certain features of an exemplary process for use in a mobile device to transition from a later radio signal to an earlier radio signal, in accordance with an implementation.

FIG. 4C is a flow diagram illustrating certain features of another exemplary process for use in a mobile device to transition from a later radio signal to an earlier radio signal, in accordance with an implementation.

### DETAILED DESCRIPTION

Some example techniques are presented herein which may be implemented in various method and apparatuses in a mobile device to possibly provide for or otherwise support a more seamless transition between an Internet-based radio signal and a broadcast radio signal 132 in a mobile device.

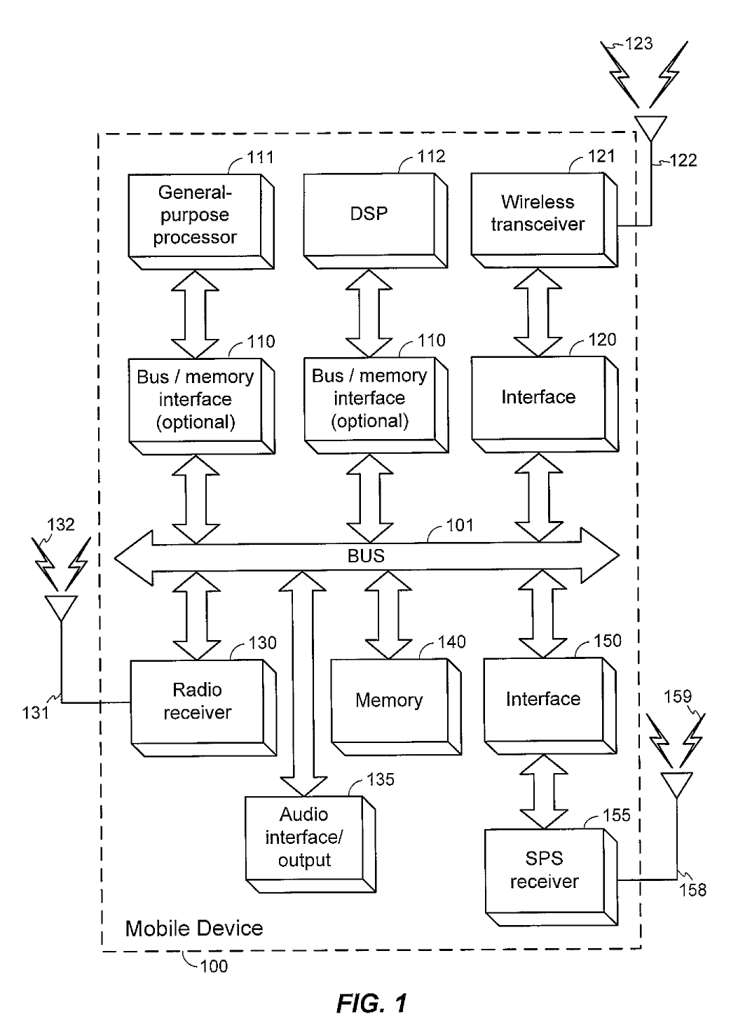

For example, in certain implementations, as illustrated in FIG. 1, a mobile device 100 may contain a wireless transceiver 121 which is capable of sending and receiving wireless signals 123 via a wireless antenna 122 over a wireless network and connected to a bus 101 by a wireless transceiver bus interface 120. The wireless transceiver bus interface 120 may, in some embodiments be a part of the wireless transceiver 121. Some embodiments may have multiple wireless transceivers 121 and wireless antennas 122 to support multiple standards such as WiFi, CDMA, WCDMA, LTE and Bluetooth.

Also illustrated in FIG. 1, certain embodiments of mobile device 100 may contain a radio receiver 130 connected to the mobile device 100 via suitable interface which may be integrated with the radio receiver 130. Radio receiver 130 is capable of receiving a broadcast radio signal 132 such as from AM or FM stations via radio antenna 131.

Also illustrated in FIG. 1, certain embodiments of mobile device 100 may contain a Satellite Positioning System (SPS) receiver 155 capable of receiving Satellite Positioning System (SPS) signals 159 via SPS antenna 158. SPS receiver 155 may also process, in whole or in part, the Satellite Positioning System (SPS) signals 159 and use the SPS signals 159 to determine the location of the mobile device. In some embodiments, general-purpose processor(s) 111, memory 140, DSP(s) 112 and specialized processors (not shown) may also be utilized to process the SPS signals 159, in whole or in part, and/or calculate the location of the mobile device 100, in conjunction with SPS receiver 155. The storage of SPS or other location signals may be done in memory 140 or registers.

Also shown in FIG. 1, mobile device 100 may contain DSP(s) 112 connected to the bus 101 by a bus interface 110, general-purpose processor(s) 111 connected to the bus 101 by a bus interface 110 and memory 140, also sometimes connected to the bus by a bus interface 110. The bus interfaces 110 may be integrated with the DSP(s) 112, general-purpose processor(s) 111 and memory 140 with which they are associated. In various embodiments, functions may be stored as one or more instructions or code in memory 140 such as on a computer-readable storage medium, such as RAM, ROM, FLASH, or disc drive, and executed by general-purpose processor(s) 111, specialized processors, or DSP(s) 112. Memory 140 is a processor-readable memory and/or a computer-readable memory that stores software code (programming code, instructions, etc.) configured to cause the processor(s) 111 and/or DSP(s) 112 to perform functions described.

In other embodiments, functions may be performed in hardware.

Also shown in FIG. 1, audio interface/output 135 is included in mobile device 100 and converts radio signals to audible sound to enable transmission of the audible sound to the user.

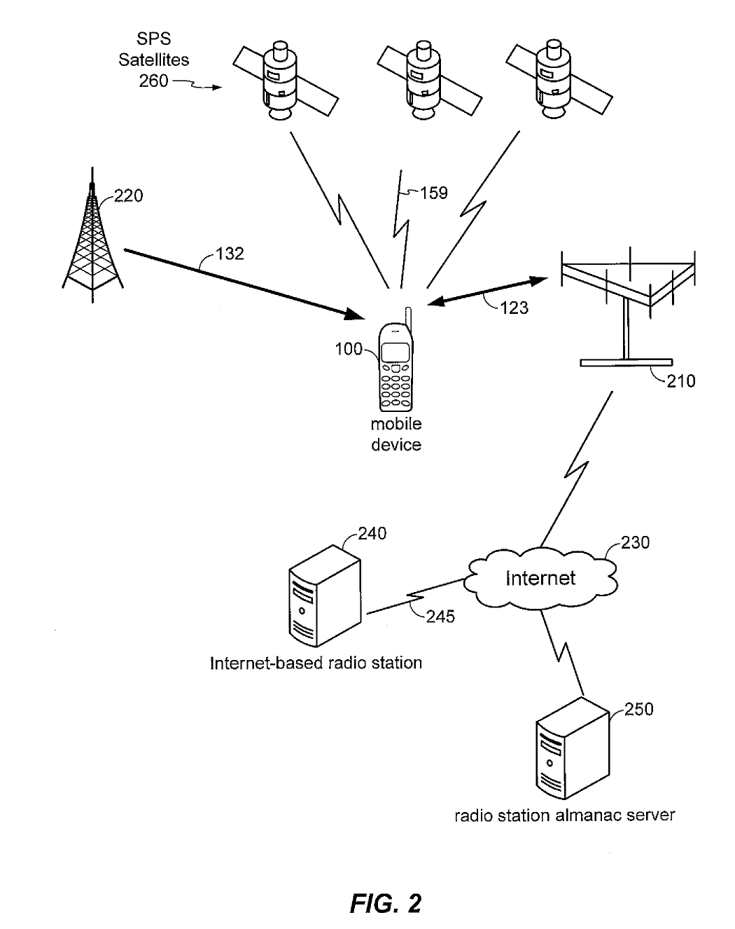

In certain implementations, as shown in FIG. 2, a mobile device 100 may receive SPS signals 159 from SPS Satellites 260. In some embodiments, the SPS Satellites may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems.

In addition, the mobile device 100 may receive a broadcast radio signal 132 from an AM or FM station 220. Reception of the broadcast radio signal 132 may be geographically limited to a broadcast range from an AM or FM station 220. Radio signals may also be available to the mobile device 100 over a wireless network 210 via wireless signals 123. The wireless network 210 may receive the Internet radio signals 245 over the Internet 230 from an Internet-based radio station 240. The Internet-based radio station 240, in some embodiments, will transmit over the Internet 230, the same programming as the broadcast radio signal 132 from a corresponding AM or FM station 220. However, the Internet radio signal 245 made available over the Internet 230 and communicated to the mobile device over wireless signals 123 is typically delayed when compared to the broadcast radio signal 132.

In addition, the mobile device 100 may query a radio station almanac server 250 on the wireless network 210 or on the Internet 230, to determine what AM or FM radio stations are available at the mobile device's location. The radio station almanac server 250 maintains a list of radio stations that may be looked up by location. Location may be specific such as a particular point or a region of a particular radius or area surrounding a particular point, or location may be general such as within a particular city or county boundary.

To determine available radio stations, the mobile device 100 first determines its location. The mobile device 100 may determine its location by various means including via the use of SPS Satellites 260 from various GNSS, the location of nearby base stations on the wireless network 210, the location of other ground based transceivers or other location determination techniques. The location of the mobile device 100 is forwarded to the radio station almanac server where the location is used to look up radio stations within range of that location. The radio station almanac server 250 may, in one embodiment, return to the handset a list of stations within range of the specified location or may respond directly to a query as to whether a particular station is within range of that location. In another embodiment, if the requested station is not within range of the location, the radio station almanac server 250 may return similar stations that may be of interest to the listener. For example, if a public radio station is requested and not available, other similar public radio stations might be provided. The radio station almanac server 250 may also return frequency and mode of transmission (AM, FM, digital, etc.) for the desired radio station.

Also note, in some embodiments, the radio station almanac, or some portion thereof, may be stored directly on the mobile device 100. In such embodiments, the station lookup is also done directly on the mobile device 100.

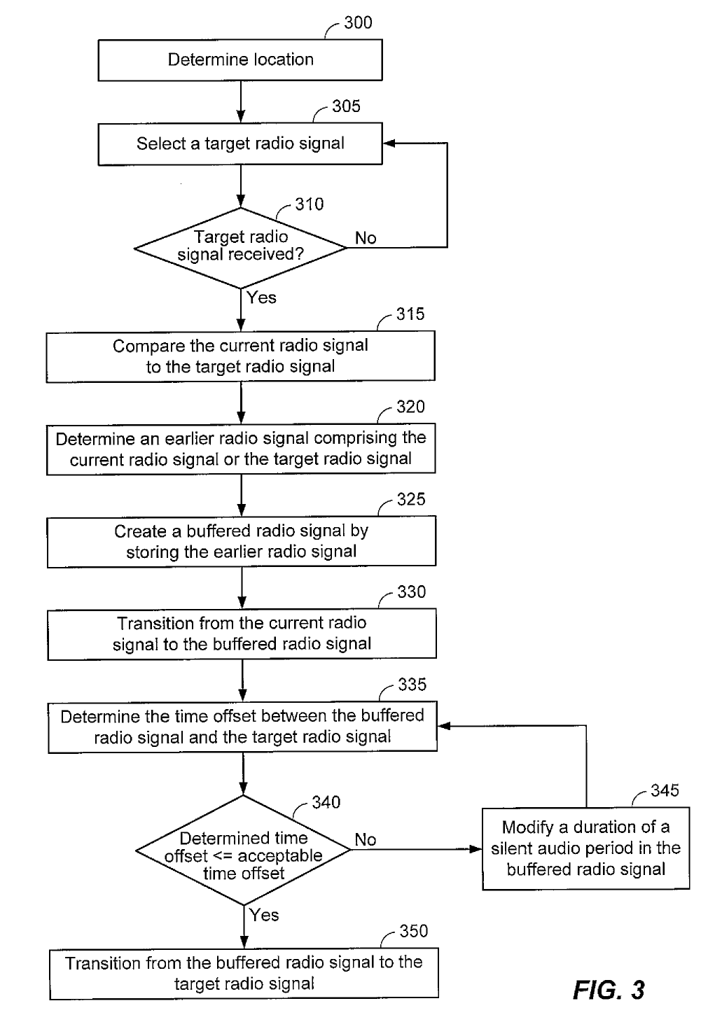

In certain implementations, referring also to FIG. 3, the mobile device 100 may, in stage 300, determine location. Location may be determined by a variety of means such as through the use of various GNSS such as GPS and Glonass, through the use of shorter range transceivers such as Bluetooth and WiFi, or through the use of wide area communication networks such as cellular networks using technologies such as LTE, CDMA, GSM, and WCDMA. For example, the location of a transceiver may be used as the location of the mobile device 100 or the mobile device 100 may use trilateration, triangulation or other means to ascertain its location from the location of remote transmitters.

The mobile device 100 may, in stage 305, select a target radio signal. Selection of a target radio signal consists of determining which radio signal the mobile should receive. This may be determined by scanning all available radio signals at a given location to find the same radio station and offset radio signal or this may be determined by looking up the equivalent radio signal either through an Internet connection to a radio station almanac available on a radio station almanac server 250 or through a radio station almanac, or some subset thereof, stored on the mobile device. In other embodiments, the target radio signal identity and characteristics may be provided either proactively as part of an existing Internet radio signal or upon query to the Internet-based radio station.

In some embodiments, selection of the target radio signal 305 is automatically initiated based upon the mobile device 100 entering a location where the target signal is available and of sufficient signal quality and/or signal strength for acceptable reception and/or sound quality. Similarly, in such embodiments, transition off of the current signal (a.k.a., the former target signal) may be automatic based on deterioration of the current signal such that signal quality and/or strength is no longer sufficient for acceptable reception or on entering a location where the target signal is deemed to be unavailable. Also, in some embodiments the transition between signal sources and the selection of the target radio signal 305 may be initiated by user action. In some embodiments the transition between signal sources and the selection of the target radio signal 305 may be subject to a user override when the user prefers to remain on the same signal source. The override may be specified by a user action or by a system setting or configuration.

In some embodiments, the user is notified of a transition or pending transition between signal sources. Such notification may occur prior to the entire signal source transition process, for example, prior to stage 300, at any stage during the transition process, for example, during any of stages 300 through 350, or after the signal source transition process, for example, after stage 350.

In some embodiments, when the mobile device 100 is currently utilizing an Internet radio signal, the target radio signal may be a broadcast radio signal 132. Similarly, when the mobile device 100 is currently utilizing a broadcast radio signal 132, the target radio signal may be an Internet radio signal. If the target radio signal is an Internet radio signal, stage 300, determine location, is not necessary as an Internet radio signal is generally accessible from any point that the Internet is accessible from and may, in some instances, be omitted. In the general case, the Internet may be accessible wherever there is coverage by the wireless network 210.

Where the target radio signal is a broadcast radio signal 132, it is desirable to know that broadcast radio signal 132 is accessible and at what frequency and mode (e.g., AM, FM, digital, etc.) it is accessible from the location of the mobile device 100. In some embodiments a scan for channels may be performed to determine broadcast radio signal 132 is accessible and at what frequency and mode (e.g., AM, FM, digital, etc.) it is accessible from the location of the mobile device 100. In some embodiments, stations, frequencies, modes and other useful information such as background information, name, and current content, or subsets thereof, may be available from the radio station almanac server 250. In other embodiments, the radio station almanac server 250 may provide timing offset estimates between the broadcast and Internet signals.

In stage 310, the mobile device attempts to receive the target radio signal. If the target radio signal is received, as shown in stage 310, and, assuming that both the current radio signal and the target radio signal are from the same station, they will typically be the same or approximately the same signal subject to varying delays such as those caused by transmission or those resulting from pre-recording and a subsequent delay in making the radio signal available on each medium. The estimated delay could be provided to the mobile device 100 via the radio station almanac server 250 or it could be determined by comparing the current radio signal to the target radio signal as in stage 315. The comparing could be done, in some embodiments, by signal correlation or by matching relative signal amplitudes and waveforms, timing markers in the signal or frequency content.

In stage 320, the mobile device determines which signal is earlier, typically the broadcast radio signal 132, and which is later, typically the Internet radio signal 245. The earlier signal is defined as the radio signal which arrives first at the mobile device 100 and the later signal is defined as the radio signal which arrives later or last at the mobile device 100. Thus, the earlier signal is ahead in phase when compared to the later phase. Also note that the current radio signal is whichever radio signal is currently used by the mobile device 100 in the audio interface/output 135 or otherwise designated in the mobile device 100 as the current signal, such as by user selection. Also, in some scenarios, the broadcast radio signal 132 may be a delayed transmission that comes out later than the Internet radio signal 245.

In stage 325, the mobile device creates a buffered radio signal by storing the earlier radio signal. The storing process may be a limited buffered copy or an ongoing copy of the earlier radio signal, or parts thereof, until the actual transition occurs between the current radio signal and the target radio signal.

In stage 330, the mobile device transitions from outputting the current radio signal to outputting the buffered radio signal. The output of either radio signal may be accomplished through audio interface/output 135. If the current signal is the earlier signal, the current radio signal and the buffered radio signal are initially, at least approximately, in synch with each other and the transition in stage 330 would generally not interrupt the current audio stream in a noticeable way. The transition could also occur during a silent audio period to avoid content interruption.

However, in stage 330, if the current signal is the later signal, the buffered radio signal may be delayed prior to transition to the buffered radio signal, to synchronize the buffered signal and the current signal. In either scenario, the current signal and at least the leading part of the buffered radio signal are synchronized prior to transitioning audio output from the current radio signal to the buffered radio signal. It is understood that, in some embodiments, a broadcast radio signal 132 may need to be converted into a digital signal to allow buffering, comparison, shifting, filtering and/or modification of the signal, where appropriate, including, where necessary, filtering out of noise in the broadcast radio signal 132. In other embodiments, some or all of these operations may be done directly on the analog signal, for example, where an analog filter is applied directly to the broadcast radio signal 132.

Stages 335 through 345 synchronize the buffered radio signal with the target radio signal prior to a transition from outputting the buffered radio signal to outputting the target radio signal in stage 350. Outputting either radio signal may be accomplished via audio interface/output 135.

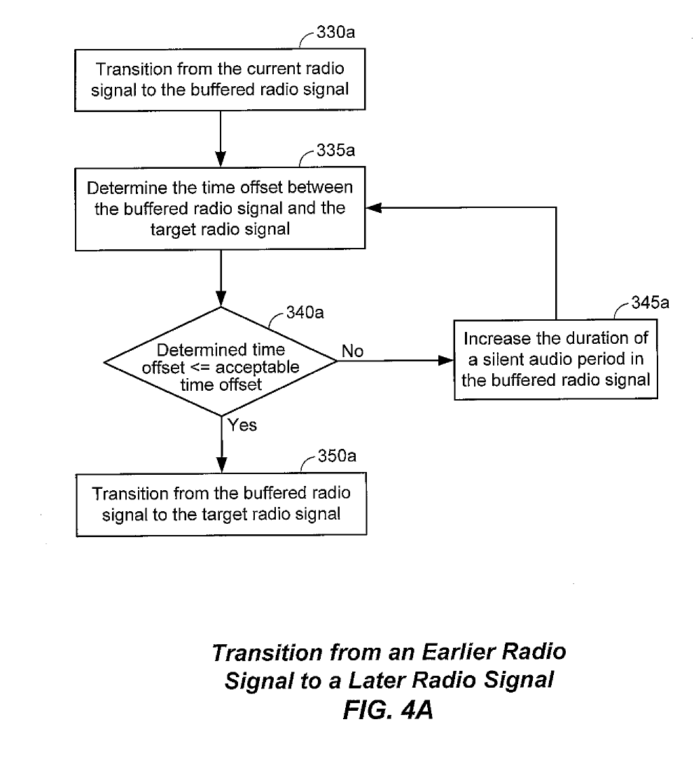

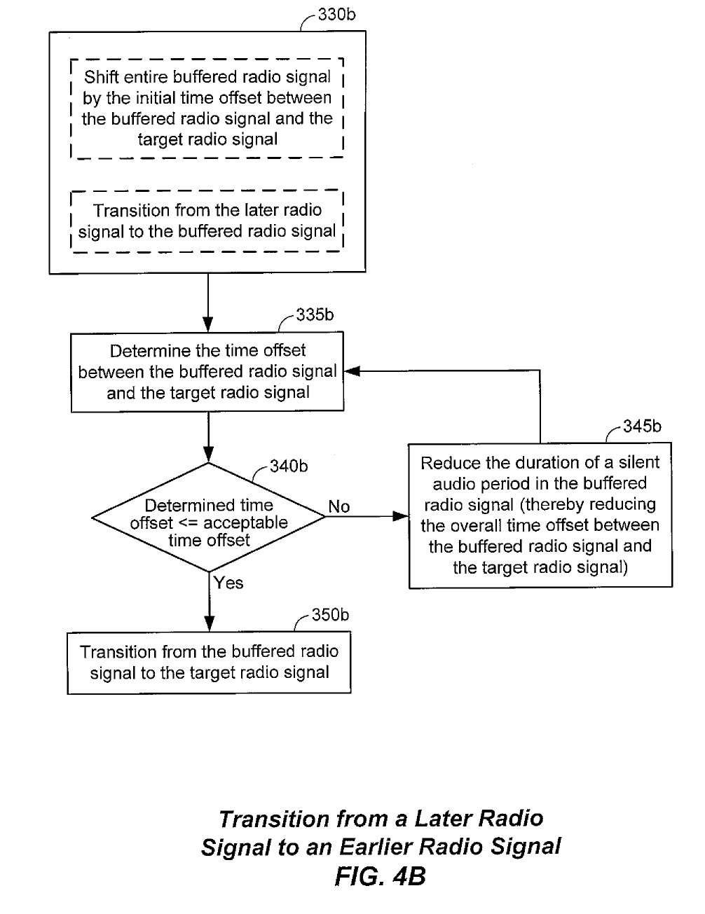

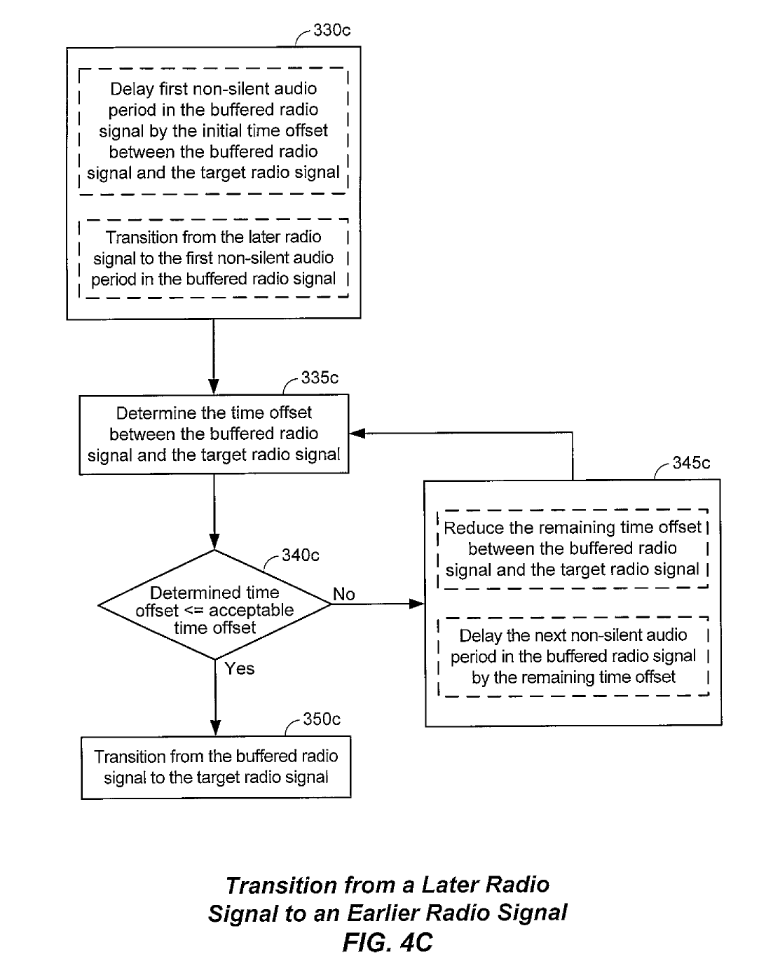

The implementation of stages 335 through 345 may vary depending on whether the transition is from a later radio signal to an earlier radio signal or from an earlier radio signal to a later radio signal. Several sample embodiments are shown in FIGS. 4A, 4B and 4C. Note that the transition from an earlier radio signal to a later radio and the transition from a later radio signal to an earlier radio signal may be implemented independent of the other or both may be implemented.

Silent audio period is may, in some embodiments, be defined as periods with audio below a threshold volume. Note, however, that, in other embodiments, a variety of other audio conditions may be designated as a silent audio period. For example, periods with repetitious or extended similar sound such as an extended vowel as in “ya'all” could be designated as a silent audio period subject to modification. Another embodiment involves designating periods containing little or no meaningful content such as repetition of the word “ah” or “uh huh” between phrases as silent audio periods. Three sample embodiments are detailed below. It is understood that other possible embodiments are possible, for example, using some of the variations and options described throughout.

Where the mobile device is switching from a from an earlier radio signal, typically a broadcast radio signal, to a later radio signal, typically an Internet radio signal, the buffered radio signal will initially be ahead of the target radio signal. This scenario is shown in FIG. 4A. Note that the reference numbers from FIG. 3 are re-used in FIG. 4A with the added suffix “a” to designate an embodiment where the mobile device is switching from an earlier radio signal to later radio signal. As shown in FIG. 4A, the effect of stage 345a will be to increase the duration of successive silent audio periods incrementally. The successive increase of silent audio periods results in an incremental increase in the total remaining signal delay until the remaining buffered radio signal is within an acceptable time offset of the target radio signal, here, the later radio signal. As shown in stage 340a, the remaining buffered radio signal is within an acceptable time offset of the target radio signal when the offset between the buffered radio signal and the target radio signal, i.e., the determined time offset, is less than or equal to an acceptable time offset. Also, note that the acceptable time offset may be predetermined or the acceptable time offset may be adjustable such as by the user via a transition quality setting. Once the determined time offset is less than or equal to the acceptable time offset, as determined in stage 340a, the mobile device may transition from the buffered radio signal to the target radio signal, as shown in stage 350a. The transition in stage 350a may also be satisfied by a condition, in stage 340a, where the determined time offset is negative, i.e., where the target radio signal is earlier than the modified buffered radio signal.

FIG. 4B shows an embodiment in which the mobile device is switching from a from a later radio signal to an earlier radio signal. Note, the reference numbers from FIG. 3 are re-used in FIG. 4B with the added suffix “b” to designate one embodiment where the mobile device is switching from a later radio signal to an earlier radio signal. In this embodiment, the buffered radio signal, as derived from the earlier radio signal, will initially be ahead of the target radio signal but is shifted, in stage 330b, to initially be accessed in sync with the target radio signal. This facilitates, also in stage 330b, a transparent transition from the later radio (here, the current radio signal) to the buffered radio signal or leading part thereof. Successive passes through stage 335b, determination of the time offset between the buffered radio signal and the target radio signal, stage 340b, where determined time offset is compared to the acceptable time offset, and stage 345b, reduction of the duration of a silent audio period in the buffered radio signal (thereby reducing the overall time offset between the buffered radio signal and the target radio signal), will result in incremental reductions of the determined time offset until it is less than or equal to the acceptable time offset. It is also recognized that stage 335b, determination of the time offset between the buffered radio signal and the target radio signal, may be merged into stage 330b on the first pass where the determined time offset is calculated to determine the initial shift of the buffered radio signal. Once the determined offset is less than or equal to the acceptable time offset, the mobile may, in stage 350b, transition from the buffered radio signal to the target radio signal.

Various techniques may be employed to determine how much the duration of each successive silent audio period in the buffered radio signal is reduced, one such technique being a reduction that is proportionate to the overall length of the silent audio period. Another technique involves doing all the reduction or most of the reduction in a silent audio period or periods over a pre-determined duration. In some embodiments, the last reduction may be calculated based solely on the remaining time offset, where the reduction would otherwise result in a negative determined time offset, i.e., and an over-reduced condition.

FIG. 4C shows another embodiment in which the mobile device is switching from a from a later radio signal to an earlier radio signal. Note, that the reference numbers from FIG. 3 are re-used in FIG. 4C with the added suffix “c” to designate another embodiment where the mobile device is switching from a later radio signal to and earlier radio signal. In this embodiment, the buffered radio signal, as derived from the earlier radio signal, will initially be ahead of the target radio signal. However, as opposed to the embodiment illustrated in FIG. 4B, in this embodiment, rather than shifting the entire buffered signal, instead, each non-silent audio period is delayed independently by successively decreasing amounts. This embodiment has a net effect of reducing each successive silent audio period to reduce the net determined time offset. This embodiment is advantageous where there is minimal delay between the buffered radio signal and the later radio signal. In such an instance, each non-silent audio period may be delayed by the applicable amount as it is added to the buffer and the buffer main contain only one for a few non-silent audio periods at a given time.

Thus, in FIG. 4C, stage 330c, the first non-silent audio period in the buffered radio signal is delayed by the initial time offset between the buffered radio signal and the target radio signal, here, the later audio signal. This facilitates, also in stage 330c, a smooth transition from the later radio signal to the first non-silent audio period in the buffered radio signal. In some embodiments, the first reduction of the remaining time offset may be implemented as a first sub-stage in stage 330c, in which case, the first non-silent audio period in the buffered radio signal may be delayed by the reduced determined time offset rather than the initial determined time offset. The delay of subsequent non-silent audio periods is successively reduced in stage 335c through stage 345c. Thus, in stage 335c, the remaining time offset between the buffered radio signal and the target radio signal is determined. In some embodiments, this determination may be based on calculations or the results of calculations that occurred elsewhere such as in stage 330c or stage 345c. In stage 340c, the determined time offset is compared to the acceptable time offset and, if the determined time offset is greater than the acceptable time offset, the method proceeds to stage 345c, where the determined time offset between the buffered radio signal and the target radio signal is reduced and the next silent audio period in the buffered radio signal is delayed by the new determined time offset. Stages 335c through 345c repeat until the determined time offset is less than or equal to the acceptable time offset. Once the determined time offset is less than or equal to the acceptable time offset, in stage 350c, the mobile device transitions from the buffered radio signal to the target radio signal.

Note, also, that the mobile device 100 may maintain simultaneous connectivity to both the Internet-based radio station 240 and the AM or FM station 220 for the duration of the transition from the current radio station to the target radio station. In other embodiments, the mobile device may terminate the connection to the current radio signal once the current signal has been buffered for a period long enough to effect a smooth transition from the buffered signal to the target signal. Also note, if the buffered signal is insufficient for a smooth transition to the target signal, the current signal may, on an ongoing basis, be input and appropriately shifted into the buffered signal until the buffered signal is sufficient for a smooth transition to the target signal or until transition to the target signal is otherwise completed.

The acceptable time offset may be predetermined or may be adjustable. Also, the net effect of reducing the duration of silent audio periods until the buffered non-silent audio is within an acceptable time offset, is the same as with the embodiment shown in FIG. 4B.

The duration of a silent audio period is modified by an amount that may vary in different embodiments. For example, in some embodiments the modification to each silent audio period may be identical in each successive silent audio period. In other embodiments, the modification to each silent audio period may be proportional to the size of the audio period, long periods being modified more than shorter periods. Other embodiments may utilize different algorithms for modifying the silent audio periods such as modifying the duration of only one silent audio period, or by modifying the silent audio periods only for silent audio periods with duration over a designated threshold duration.

In some embodiments, broadcast quality is monitored. For example, the monitored parameters may comprise signal quality and signal strength where the desired broadcast quality or strength may be user settable/adjustable. In these embodiments, stage 310, determination of whether a target radio signal is available, may be additionally dependent upon whether the selected target radio signal of stage 305 has sufficient signal quality and/or signal strength.

Also, the mobile device, in stage 300 (FIG. 3), may utilize the location of the device to determine what local stations are available. The user interface for the radio or other broadcast receiving application may note stations that are in the area, regardless of whether they can be received or whether their reception quality is good at the current location. However, those stations that are in the area that are either not being received or are being received with poor quality broadcasts that were made available via the Internet radio signal may not, in some embodiments, trigger a transition to the broadcast radio signal. Furthermore, in some embodiments, it may be user-transparent whether a station is being delivered via AM/FM or other broadcast radio signal or if the radio signal is being provided over the Internet and/or other wireless data connection.

Also, in some embodiments, stage 300, determine location, may be replaced by direct user request for a switch to a broadcast radio signal and a subsequent frequency scan for a corresponding signal that matches the existing Internet radio signal.

In some embodiments, during the transition from the current radio signal to the target radio signal, the mobile device utilizes a simultaneous connection to an Internet-based broadcast and also to an AM/FM broadcast of the same programming. Also or alternatively, the transition may be accomplished with a pre-buffered signal.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, the claimed subject matter is not limited to the particular examples disclosed, but such claimed subject matter may also include all aspects falling within the scope of appended claims, and equivalents thereof.

The methodologies described herein may be implemented by various means. For example, these methodologies may be implemented in hardware, firmware, software, or any combination thereof. For an implementation involving hardware, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

1. A method comprising, at a mobile device:
creating a buffered radio signal by storing whichever of a current radio signal or a target radio signal represents an earlier radio signal;
in response to a determination that an initial time offset between the buffered radio signal and the target radio signal; exceeds an acceptable time offset, while continuously outputting a content stream generated based on the buffered radio signal, temporally modifying one or more portions of the content stream until a subsequent time offset between the buffered radio signal and the target radio signal satisfies the acceptable time offset; and
in response to a determination that the initial time offset or the subsequent time offset satisfies the acceptable time offset, transitioning the mobile device from outputting the content stream generated based on the buffered radio signal to outputting a corresponding content stream generated based on the target radio signal.

2. The method of claim 1, further comprising determining a location of the mobile device.

3. The method of claim 2, the target radio signal and further comprising, at the mobile device:
determining if the target radio signal is available at the location of the mobile device; and
if the target radio signal is unavailable at the location of the mobile device, selecting a new target radio signal.

4. The method of claim 3, wherein determining if the target radio signal is available at the location of the mobile device comprises:
receiving the identity of the target radio; and
scanning for the target radio signal.

5. The method of claim 3, wherein the location of the mobile device is determined, at least partly, through identification of a communication transceiver in communication with the mobile device.

6. The method of claim 3, wherein the location of the mobile device is determined, at least partly, through receipt and processing of Global Navigation Satellite System signals.

7. The method of claim 1, wherein the current radio signal comprises an Internet radio signal and the target radio signal comprises a broadcast radio signal.

8. The method of claim 1, wherein the current radio signal comprises a broadcast radio signal and the target radio signal comprises an Internet radio signal.

9. The method of claim 1, wherein temporally modifying the content stream further comprises:
modifying a duration of a silent audio period in the content stream.

10. The method of claim 9, wherein the silent audio period contains an audio signal level below a pre-determined threshold.

11. A mobile device comprising:
means for creating a buffered radio signal by storing whichever of a current radio signal or a target radio signal represents an earlier radio signal;
means for determining an initial time offset between the buffered radio signal and the target radio signal;
means for temporally modifying one or more portions of a content stream based on the buffered radio signal while the content stream is being continuously output by the mobile device, in response to a determination that the initial time offset exceeds an acceptable time offset, at least until a subsequent time offset between the buffered radio signal and the target radio signal satisfies the acceptable time offset; and
means for transitioning the mobile device from outputting the content stream generated based on the buffered radio signal to outputting a corresponding content stream generated based on the target radio signal, in response to a determination that the initial time offset or the subsequent time offset satisfies the acceptable time offset.

12. The mobile device of claim 11, further comprising means for determining a location of the mobile device.

13. The mobile device of claim 12, and further comprising:
means for determining if the target radio signal is available at the location of the mobile device; and
means for selecting a new target radio signal if the target radio signal is unavailable at the location of the mobile device.

14. The mobile device of claim 13, wherein the means for determining if the target radio signal is available at the location of the mobile device comprises:
means for receiving the identity of the target radio; and
means for scanning for the target radio signal.

15. The mobile device of claim 13, wherein the location of the mobile device is determined, at least partly, through identification of a communication transceiver in communication with the mobile device.

16. The mobile device of claim 13, wherein the location of the mobile device is determined, at least partly, through receipt and processing of Global Navigation Satellite System signals.

17. The mobile device of claim 11, wherein the current radio signal comprises an Internet radio signal and the target radio signal comprises a broadcast radio signal.

18. The mobile device of claim 11, wherein the current radio signal comprises a broadcast radio signal and the target radio signal comprises an Internet radio signal.

19. The mobile device of claim 11, and further comprising;
means for modifying a duration of a silent audio period in the content stream generated based on the buffered radio signal.

20. The mobile device of claim 19, wherein the silent audio period contains an audio signal level below a pre-determined threshold.

21. A mobile device comprising:
memory; and
one or more processing units to:
create a buffered radio signal in the memory by storing whichever of a current radio signal or a target radio signal represents an earlier radio signal;
in response to a determination that an initial time offset between the buffered radio signal and the target radio signal exceeds an acceptable time offset, while the mobile device continuously outputs a content stream generated based on the buffered radio signal, initiating a temporal modification of one or more portions of the content stream until a subsequent time offset between the buffered radio signal and the target radio signal satisfies the acceptable time offset; and
in response to a determination that the initial time offset or the subsequent time offset satisfies the acceptable time offset, initiate a transition in the mobile device from outputting the content stream generated based on the buffered radio signal to outputting a corresponding content stream generated based on the target radio signal.

22. The mobile device of claim 21, wherein the one or more processing units further determine a location of the mobile device.

23. The mobile device of claim 22, the one or more processing units to further:
determine if the target radio signal is available at the location of the mobile device; and
if the target radio signal is unavailable at the location of the mobile device, select a new target radio signal.

24. The mobile device of claim 23, the one or more processing units to further:
obtain the identity of the target radio; and
initiate a scan for the target radio signal.

25. The mobile device of claim 23, wherein the location of the mobile device is determined, at least partly, through identification of a communication transceiver in communication with the mobile device.

26. The mobile device of claim 23, wherein the location of the mobile device is determined, at least partly, through receipt and processing of Global Navigation Satellite System signals.

27. The mobile device of claim 21, wherein the current radio signal comprises an Internet radio signal and the target radio signal comprises a broadcast radio signal.

28. The mobile device of claim 21, wherein the current radio signal comprises a broadcast radio signal and the target radio signal comprises an Internet radio signal.

29. The mobile device of claim 21, the one or more processing units to further:
initiate modification of a duration of a silent audio period in the content stream generated based on the buffered radio signal.

30. The mobile device of claim 29, wherein the silent audio period contains an audio signal level below a pre-determined threshold.

31. An article comprising:
a non-transitory computer readable medium having stored therein computer executable instructions executable by one or more processing units of a mobile device to:
create a buffered radio signal by storing whichever of a current radio signal or a target radio signal represents an earlier radio signal;
in response to a determination that an initial time offset between the buffered radio signal and the target radio signal exceeds an acceptable time offset, while the mobile device continuously outputs a content stream generated based on the buffered radio signal, initiating a temporal modification of one or more portions of the content stream until a subsequent time offset between the buffered radio signal and the target radio signal satisfies the acceptable time offset; and
in response to a determination that the initial time offset or the subsequent time offset satisfies the acceptable time offset, transition the mobile device from outputting the content stream generated based on the buffered radio signal to outputting a corresponding content stream generated based on the target radio signal.

32. The article as recited in claim 31, said computer executable instructions being further executable by said one or more processing units to determine a location of the mobile device.

33. The article as recited in claim 32, said computer executable instructions being further executable by said one or more processing units to:
determine if the target radio signal is available at the location of the mobile device; and
if the target radio signal is unavailable at the location of the mobile device, selecting select a new target radio signal.

34. The article as recited in claim 33, said computer executable instructions being further executable by said one or more processing units to:
obtain the identity of the target radio; and
initiate a scan for the target radio signal.

35. The article as recited in claim 33, wherein the location of the mobile device is determined, at least partly, through identification of a communication transceiver in communication with the mobile device.

36. The article as recited in claim 33, wherein the location of the mobile device is determined, at least partly, through receipt and processing of Global Navigation Satellite System signals.

37. The article as recited in claim 31, wherein the current radio signal comprises an Internet radio signal and the target radio signal comprises a broadcast radio signal.

38. The article as recited in claim 31, wherein the current radio signal comprises a broadcast radio signal and the target radio signal comprises an Internet radio signal.

39. The article as recited in claim 31, said computer executable instructions being further executable by said one or more processing units to initiate modification of a duration of a silent audio period in the content stream generated based on the buffered radio signal.

40. The article as recited in claim 39, wherein the silent audio period contains an audio signal level below a pre-determined threshold.
